(19) United States
(12) Patent Application Publication
(10) Pub. No.: US 2025/0199482 A1
(43) Pub. Date: Jun. 19, 2025

(54) METHOD FOR PERFORMING OPERATIONS BASED ON TIMERS, AND DEVICE AND CHIP

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 19/064,240

(22) Filed: Feb. 26, 2025

Related U.S. Application Data
(63) Continuation of application No. PCT/CN2023/085548, filed on Mar. 31, 2023.

(51) Int. Cl. G04R 20/02; H04W 24/10

(52) U.S. Cl. CPC G04R 20/02; H04W 24/10

(57) ABSTRACT

Provided is a method for performing operations based on timers. The method is applicable to a terminal device, and the method includes: performing a first operation on a first timer based on first time information; wherein the first time information is time information related to a global navigation satellite system (GNSS) measurement and/or a satellite switch.

### CROSS-REFERENCE TO RELATED APPLICATION

This application is a continuation of International Application No. PCT/CN2023/085548, filed Mar. 31, 2023, the entire disclosure of which is incorporated herein by reference.

### TECHNICAL FIELD

The present disclosure relates to the technical field of communications, and in particular, relates to a method and apparatus for performing operations based on timers, and a device, a medium and a product thereof.

### RELATED ART

Currently, the 3^{rd} Generation Partnership Project (3GPP) is working on non-terrestrial network (NTN) technologies.

### SUMMARY

Embodiments of the present disclosure provide a method for performing operations based on timers, and a device and a chip thereof. The technical solutions are as follows:

According to some embodiments of the present disclosure, a method for performing operations based on timers is provided. The method includes:
performing a first operation on a first timer based on first time information.

The first time information is time information related to a GNSS measurement and/or a satellite switch.

According to some embodiments of the present disclosure, a chip is provided. The chip includes a programmable logic circuit and/or one or more program instructions. A communication device equipped with the chip, when running, is caused to perform the method for performing operations based on timers described above.

According to some embodiments of the present disclosure, a terminal device is provided. The terminal device includes a processor; a transceiver connected to the processor; and a memory configured to store one or more executable instructions. The processor is configured to load and execute the one or more executable instructions, to cause the terminal device to perform the method for performing operations based on timers described above.

### BRIEF DESCRIPTION OF DRAWINGS

For clearer descriptions of the technical solutions according to the embodiments of the present disclosure, the accompanying drawings required for describing the embodiments are briefly introduced hereinafter. Apparently, the accompanying drawings in the following description show merely some embodiments of the present disclosure, and those of ordinary skill in the art may still derive other drawings from these accompanying drawings without creative efforts.

FIG. 1 is a schematic diagram of a communication system according to some embodiments of the present disclosure;

FIG. 2 is a flowchart of a method for performing operations based on timers according to some embodiments of the present disclosure;

FIG. 3 is a flowchart of a method for performing operations based on timers according to some embodiments of the present disclosure;

FIG. 4 is a flowchart of a method for performing operations based on timers according to some embodiments of the present disclosure;

FIG. 5 is a flowchart of a method for performing operations based on timers according to some embodiments of the present disclosure;

FIG. 6 is a block diagram of an apparatus for performing operations based on timers according to some embodiments of the present disclosure;

FIG. 7 is a block diagram of an apparatus for performing operations based on timers according to some embodiments of the present disclosure; and

FIG. 8 is a schematic structural diagram of a terminal device according to some embodiments of the present disclosure.

### DETAILED DESCRIPTION

For clearer descriptions of the objective, technical solutions, and advantages of the present disclosure, the embodiments of the present disclosure are further described in detail hereinafter with reference to the accompanying drawings.

First, related technologies involved in the embodiments of the present disclosure are described as follows.

### (1) GNSS Operation

In Release 17 (R17) Internet of things (IoT) NTN, namely a scenario in which Narrowband IoT (NB-IoT) and enhanced machine type communication (eMTC) are integrated into an NTN, a GNSS measurement module and communication module of an IoT terminal fail to operate simultaneously. In the R17 NTN, the IoT terminal is capable of performing a GNSS measurement to obtain position information only in a radio resource control (RRC) idle state or an RRC inactive state, but is incapable of starting a GNSS module in an RRC connected state. Therefore, before entering the RRC connected state, a user equipment (UE) needs to obtain a GNSS position thereof by performing a measurement using the GNSS module. The UE may determine a validity period of the GNSS position based on its own situation (such as a mobile state of the UE), and report the remaining validity period of the GNSS position to a network during an RRC connection establishment/RRC re-establishment/RRC connection recovery. In the case that the GNSS position of the UE in the RRC connected state expires, the UE fails to calculate uplink time alignment (TA) because the UE is incapable of performing a GNSS operation in the RRC connected state. Therefore, the UE needs to return to the RRC idle state.

In a work item description (WID) (RP-213596) for Release 18 (R18) IoT NTN enhancement, the following research objectives are explicitly given:
4.1.1 IoT-NTN Performance Enhancements in Rel-18 to address remaining issues from Rel-17

This work considers Rel-17 IoT-NTN as baseline as well as Rel-17 NR-NTN outcome and the further IoT-NTN performance enhancements objectives are listed below:
Disabling of HARQ feedback to mitigate impact of HARQ stalling on UE data rates [RAN1, RAN2]
Study and specify, if needed, improved GNSS operations for a new position fix for UE pre-compensation during long connection times and for reduced power consumption [RAN1]

Based on the above research objectives, an IoT terminal accessing an NTN in R18 is capable of performing a GNSS operation in the RRC connected state.

In 3GPP Radio Access Network Working Group 1 (RAN1) Meeting #109, RAN1 discussed GNSS enhancement for an IoT terminal accessing an NTN and reached the following conclusions:
1. An IoT NTN UE may need to re-obtain a valid GNSS measurement position during a long-lasting RRC connection.
2. For a GNSS measurement in the connected state, at least the following candidate schemes may be considered:
Scheme 1: A terminal device based on timer control re-obtains a GNSS measurement position.
Scheme 2: A new gap is introduced, and a terminal device re-obtains a GNSS measurement position during the gap.
3. To trigger a GNSS measurement in the connected state, the following may be considered:
a GNSS measurement triggered by a terminal device; and
a GNSS measurement triggered by a network device.

### (2) Hard Satellite Switch

For a quasi-earth fixed cell, terrestrial coverage of a low Earth orbit (LEO) mobile satellite is fixed for a period of time. A terminal device may need to perform a satellite switch in the RRC connected state. For example, an elevation angle of a current satellite gradually decreases as it moves to terrestrial coverage, and the current satellite is no longer capable of providing coverage for a current region at a specific moment. At this time, a new satellite may take over to provide coverage for the current region. The new satellite may be connected to a same ground gateway. From the perspective of the terminal device, the two satellites have a same physical cell identifier (PCI) and frequency. To prevent co-channel interference between the satellites, it is more realistic to perform a hard switch between the satellites. That is, the terminal device is disconnected from the current satellite and then establishes a connection to the new satellite.

### (3) Radio Link Monitoring (RLM)

RLM is used for monitoring downlink channel quality of a serving cell. A physical layer evaluates radio link quality within a specified time period and compares the radio link quality with a Qin threshold and a Qout threshold. In the case that the radio link quality is lower than the Qout threshold, the physical layer reports an out-of-sync indication to a higher layer. In the case that the radio link quality is higher than the Qin threshold, the physical layer reports an in-sync indication to the higher layer. The Qin threshold and the Qout threshold are determined by detecting a block error rate (BLER) of a physical downlink control channel (PDCCH) format 1-0. BLERs corresponding to the Qin threshold and the Qout threshold are configured using RRC signaling. The BLER corresponding to the Qout threshold is 10%. The BLER corresponding to the Qin threshold is 2%.

Downlink out-of-sync determination by the UE on a network side involves the following timer and constants: N310, T310, and N311. These timer and constants may be configured for the UE using dedicated signaling. In the case that they are not configured, parameters in a system broadcast message are used.

In the case that the UE in the RRC connected state receives a maximum quantity of “out_of_Sync” events indicated by the first parameter N310, and the timer T310, a timer T301, a timer T304, and a timer T311 are not running, the timer T310 is started. In the case that a maximum quantity of “in_Sync” events indicated by the second parameter N311 is received, the timer T310 is stopped, indicating that the UE has recovered downlink synchronization. Otherwise, the UE is in a downlink out-of-sync state.

A data inactivity timer is configured to control data inactivity. This parameter is configured in the RRC connected state in seconds(s). A start of the data inactivity timer is controlled by a medium access control (MAC) layer. The data inactivity timer is started or restarted in the case that the MAC layer transmits or receives a dedicated traffic channel (DTCH), a dedicated control channel (DCCH), or a common control channel (CCCH). In the case that the data inactivity timer expires, the MAC layer notifies an RRC layer that the data inactivity timer expires, and the terminal device switches from a connected state to an idle state.

### (4) Radio Resource Management (RRM) Measurement of UE in Non-connected State

A terminal device in the non-connected state needs to perform an RRM measurement on a serving cell and a neighboring cell based on a configuration of a network to support a mobility operation, such as cell reselection.

A measurement of UE in the non-connected state on a serving cell is ongoing. In Release 14 (R14) NB-IoT, a neighboring cell measurement relaxation mechanism for a stationary terminal device is introduced to further meet a power saving requirement of the terminal device. A measurement relaxation criterion is introduced for neighboring cell measurement relaxation. The network configures an evaluation duration (T Search Delta P) of a narrowband reference signal received power (NRSRP) change and a change threshold (S Search Delta P) of a reference signal received power (RSRP). In the case that the RSRP change of the UE on the serving cell within the evaluation duration is less than the change threshold, it is considered that the UE meets the measurement relaxation criterion. That is, within T Search Delta P, the following condition is met:
(SrxlevRef−Srxlev)<S Search Delta P

Srxlev represents a currently selected receive level measurement value of the serving cell. SrxlevRef represents a reference Srxlev value of the serving cell.

In the case that the UE selects or reselects a new cell, or (Srxlev−SrxlevRef)>0, or the UE does not meet the condition (SrxlevRef−Srxlev)<S Search Delta P within T Search Delta P, the UE sets SrxlevRef to a current Srxlev measurement value of the serving cell.

Upon completion of cell selection/reselection, the UE needs to perform a normal RRM measurement at least within the evaluation duration. In the case that the UE meets the measurement relaxation criterion, a measurement interval of the UE for neighboring cells may be increased to 24 hours.

### (5) RRM Measurement of UE in a Connected State

In releases prior to R17, NB-IoT UE did not support RRM measurements in the connected state. In the case that channel quality of NB-IoT in the connected state deteriorates on a serving cell, mobility management is performed through a radio link failure (RLF) and an RRC re-establishment procedure. After triggering an RLF, UE needs to select a suitable cell through search and measurement, and then initiate RRC connection re-establishment on the cell. To reduce an amount of time consumed by the UE to select a re-establishment cell after triggering the RLF, R17 introduces a neighboring cell measurement mechanism for NB-IoT UE in the connected state. For a neighboring cell measurement of UE in the connected state, a network configures an s-measure criterion using a system message. The network may further configure a UE mobile state evaluation criterion. The UE determines, based on the s-measure criterion and UE mobile state evaluation criterion, whether a neighboring cell measurement needs to be performed. The method is as follows:
After the UE enters an RRC connected state, in the case that the network configures the UE mobile state evaluation criterion:
NRSRP Ref is set to a last measured NRSRP on the serving cell used for cell selection or reselection.

In the case that the UE does not meet a neighboring cell measurement relaxation criterion before entering the RRC connected state, the UE starts a timer T326.

For the UE in the connected state, assuming that a measurement result of the UE on a measured carrier is NRSRP, in the case that the network configures the UE mobile state evaluation criterion:
If (NRSRP Ref−(NRSRP−Power Offset Non Anchor))>s-Measure Delta P, the UE sets NRSRP Ref=NRSRP−Power Offset Non Anchor, and the UE starts or restarts the timer T326.

If the network does not configure the UE mobile evaluation criterion or T326 is running:
If (NRSRP−Power Offset Non Anchor)<s-Measure Intra, the UE performs an intra-frequency neighboring cell measurement.
If (NRSRP−Power Offset Non Anchor)<s-Measure Inter, the UE performs an inter-frequency neighboring cell measurement.

FIG. 1 is a schematic diagram of a communication system according to some embodiments of the present disclosure. The communication system includes a communication satellite 101, a network device 102, and a terminal device 103.

The communication satellite 101 in the present disclosure provides communication services to terrestrial users (such as the network device 102 and the terminal device 103) by satellite communications. The communication satellite 101 is categorized based on an orbit altitude into a LEO satellite, a medium Earth orbit (MEO) satellite, a geostationary Earth orbit (GEO) satellite, a high elliptical orbit (HEO) satellite, or the like. Two types of communication satellites 101 are considered in 3GPP. One is a transparent payload satellite, and the other is a regenerative payload satellite.

The network device 102 according to the present disclosure provides a wireless communication function. The network device 102 includes, but is not limited to, an evolved NodeB (eNB), a radio network controller (RNC), a NodeB (NB), a base station controller (BSC), a base transceiver station (BTS), a home base station (such as a home eNB or a home NB (HNB)), a baseband unit (BBU), an access point (AP) in a wireless fidelity (Wi-Fi) system, a wireless relay node, a wireless backhaul node, a transmission point (TP), or a transmission and reception point (TRP); or may be a gNodeB (gNB), a TRP, or a TP in a 5^{th}-generation (5G) mobile communication system, one antenna panel or a group of antenna panels (including a plurality of antenna panels) of a base station in a 5G system, a network node constituting a gNB or a TP, such as a BBU or a distributed unit (DU), a base station in a beyond 5G (B5G) or 6^{th}-generation (6G) mobile communication system, a core network (CN), a fronthaul node, a backhaul node, a radio access network (RAN), a network slice, a serving cell, a primary cell (PCell), a primary secondary cell (PSCell), a special cell (SpCell), a secondary cell (SCell), or a neighboring cell of the terminal device, or the like.

The terminal device 103 according to the present disclosure is also referred to as a UE, an access terminal, a subscriber unit, a subscriber station, a mobile station, a mobile platform, a remote station, a remote terminal, a mobile device, a user terminal, a terminal, a wireless communication device, a user agent, or a user apparatus. The terminal device includes, but is not limited to, a handheld device, a wearable device, a vehicle-mounted device, and an IoT device, for example, a mobile phone, a tablet computer, an e-book reader, a laptop computer, a desktop computer, a television, a game console, a mobile Internet device (MID), an augmented reality (AR) terminal, a virtual reality (VR) terminal, a mixed reality (MR) terminal, a wearable device, a handle, an electronic label, a controller, a wireless terminal in industrial control, a wireless terminal in self-driving, a wireless terminal in remote medical, a wireless terminal in smart grids, a wireless terminal in transportation safety, a wireless terminal in smart cities, a wireless terminal in smart homes, a wireless terminal in remote medical surgery, a cellular phone, a cordless phone, a Session Initiation Protocol (SIP) phone, a wireless local loop (WLL) station, a personal digital assistant (PDA), a set top box (STB), a customer premises equipment (CPE), or the like.

The network device 102 is capable of communicating with the terminal device 103 using a specific air interface technology, such as a Uu interface. For example, two scenarios of communication are present between the network device 102 and the terminal device 103: uplink communication and downlink communication. The uplink communication means transmission of signals to the network device 102. The downlink communication means transmission of signals to the terminal device 103.

The technical solutions according to the embodiments of the present disclosure may be applicable to various communication systems, such as a global system for mobile communications (GSM), a code-division multiple access (CDMA) system, a wideband code-division multiple access (WCDMA) system, a general packet radio system (GPRS), a long-term evolution (LTE) system, an LTE frequency division duplex (FDD) system, an LTE time division duplex (TDD) system, an advanced LTE (LTE-A) system, a universal mobile telecommunications system (UMTS), a worldwide interoperability for microwave access (WiMAX) communication system, a 5G mobile communication system, a new radio (NR) system, an evolved system of the NR system, an LTE-based access to unlicensed spectrum (LTE-U) system, an NR-based access to unlicensed spectrum (NR-U) system, a terrestrial network (TN) system, an NTN system, a wireless local area network (WLAN), a Wi-Fi system, a cellular IoT system, a cellular passive IoT system, an evolved system subsequent to the 5G NR system, a B5G mobile communication system, a 6G mobile communication system, and a subsequent evolved system. In some embodiments of the present disclosure, the “NR system” may also be referred to as the 5G NR system or 5G system. The 5G mobile communication system may include a non-standalone (NSA) mode and/or a standalone (SA) mode. Description is given hereinafter using an example in which the embodiments of the present disclosure are applicable to the NTN system.

The technical solutions according to the embodiments of the present disclosure may also be applicable to machine-type communication (MTC), LTE-machine (LTE-M), a device-to-device (D2D) network, a machine-to-machine (M2M) network, an IoT network, or the like. The IoT network may include, for example, the Internet of vehicles (IoV). A communication mode in an IoV system is collectively referred to as Vehicle to X (V2X, X may represent anything). For example, the V2X communication may include vehicle-to-vehicle (V2V) communication, vehicle-to-infrastructure (V2I) communication, vehicle-to-pedestrian (V2P) communication, vehicle-to-network (V2N) communication, or the like.

The communication system in the embodiments may be applicable to, but is not limited to, at least one of: an uplink communication scenario, a downlink communication scenario, or a sidelink communication scenario.

In the related art, communication between a terminal device and a current cell is interrupted during a GNSS measurement and/or a satellite switch. In an example, in the case that a timer (such as a timer T310) configured to determine an RLF expires during the GNSS measurement and/or the satellite switch, the terminal device considers that an RLF occurs and needs to perform RRC connection re-establishment based on a relevant protocol. In this case, the terminal device may still perform RRC connection re-establishment upon completion of the GNSS measurement and/or the satellite switch. Consequently, the terminal device fails to perform data transmission in time upon completion of the GNSS measurement and/or the satellite switch. In an example, in the case that a timer (such as a data inactivity timer) configured to determine to switch from a connected state to an idle state expires during the GNSS measurement and/or the satellite switch, the terminal device needs to switch from the connected state to the idle state based on a relevant protocol. In this case, the terminal device needs to perform RRC connection re-establishment upon completion of the GNSS measurement and/or the satellite switch. Consequently, the terminal device consumes more power and fails to perform data transmission in time upon completion of the GNSS measurement and/or the satellite switch. In an example, in the case that a timer (such as a timer T326) configured to initiate a neighboring cell measurement in the connected state expires during the GNSS measurement and/or the satellite switch, the terminal device does not initiate a neighboring cell measurement upon completion of the GNSS measurement and/or the satellite switch because the timer T326 is not running. This may result in a failure to quickly discover a cell of RRC re-establishment in case of an RLF. Consequently, the terminal device fails to perform data transmission in time upon completion of the GNSS measurement and/or the satellite switch.

In the related art, communication services are provided to terrestrial users by satellite communications. Communication between a terminal device and a current cell is interrupted during a global navigation satellite system (GNSS) measurement and a satellite switch. Therefore, how to shorten a data interruption time and reduce power consumption is an urgent problem to be solved.

In view of the above problems, the present disclosure provides a method for performing operations based on timers. The method is described below.

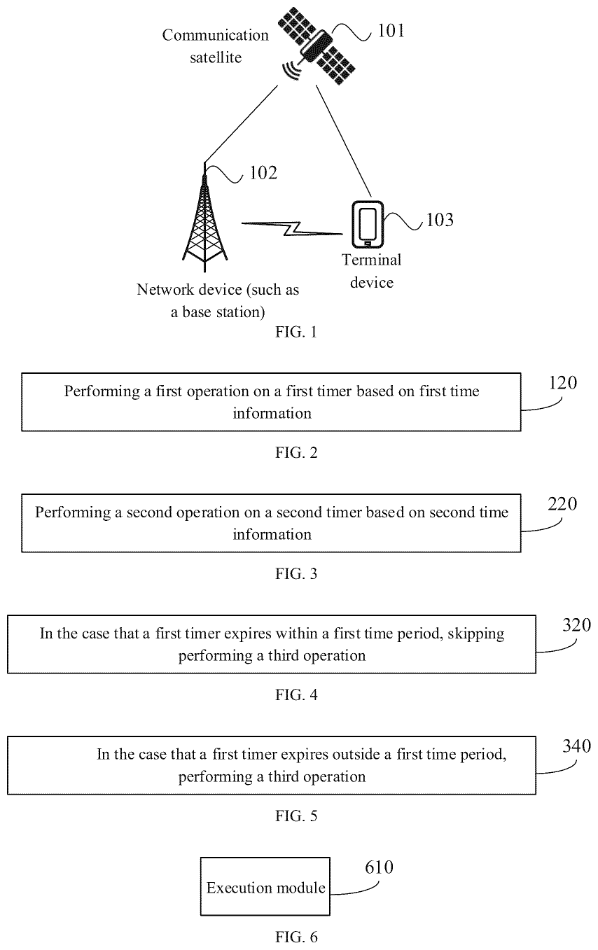

FIG. 2 is a flowchart of a method for performing operations based on timers according to some embodiments of the present disclosure. The method is applicable to a terminal device. The method includes the following process.

In process 120, a first operation is performed on a first timer based on first time information.

After the first time information is obtained, the first operation is performed on the first timer.

In some embodiments, the first time information is time information related to a GNSS measurement and/or a satellite switch. In some embodiments, the first time information is time information related to a start or initiation of the GNSS measurement. In some embodiments, the first time information is time information related to a start or initiation of the satellite switch. In some embodiments, the satellite switch includes at least one of a soft satellite switch or a hard satellite switch.

In an example, the satellite switch includes the hard satellite switch. During the hard satellite switch, to prevent co-channel interference between two communication satellites before and after the switch, the terminal device needs to disconnect from the current communication satellite and then establish a new connection to the new communication satellite during the hard satellite switch.

In some embodiments, the first time information includes at least one of: a time when the GNSS measurement is performed; a time when GNSS information expires; a start time of a GNSS measurement gap; or a start time of the satellite switch.

In some embodiments, the start time of the satellite switch is indicated by a network device (such as a base station or a core network device).

The network device indicates the start time of the satellite switch over at least one of: system message broadcasting; RRC dedicated signaling; a MAC control element (CE); or a PDCCH.

It should be understood that a time when the terminal device performs the first operation and the first time are coincident or synchronous. In general, due to a specific delay under objective conditions, the time when the first operation is performed may be slightly later than the first time.

In some embodiments, the first timer triggers an interruption of communication between the terminal device and a satellite upon expiration.

In some embodiments, the first timer includes at least one of: a timer configured to determine an RLF; or a timer configured to determine to switch from a connected state to an idle state

In some embodiments, the timer configured to determine an RLF includes a timer T310. In some embodiments, after the terminal device starts RLM, in the case that a quantity of continuously received downlink out-of-sync indications is equal to a first parameter, a start of the timer T310 is triggered. In the case that a quantity of continuously received downlink in-sync indications is equal to a second parameter during the process that the timer T310 is continuously running, the timer T310 is stopped to indicate that link synchronization has been recovered. In the case that the timer T310 expires, it is considered that an RLF is detected and an RRC connection re-establishment procedure is triggered. In some embodiments, the first parameter includes N310. In some embodiments, the second parameter includes N311.

In some embodiments, the timer configured to determine to switch from the connected state to the idle state includes a data inactivity timer. In some embodiments, in the case that the terminal device is in the connected state upon completion of data transmission, the data inactivity timer is started. In the case that the data inactivity timer expires, the terminal device switches from the connected state to the idle state.

In some embodiments, the first operation is used to prevent interruption of communication between the terminal device and the satellite. In some embodiments, the first operation is used to prevent the terminal device from continuing to run the first timer within a time period related to the GNSS measurement and/or the satellite switch.

In some embodiments, the first operation includes: stopping the first timer; or pausing the first timer.

In an example, based on the first time information, the timer T310 is stopped and/or the data inactivity timer is stopped. In some embodiments, the term “stopped” may be understood as that the first timer is canceled or a count value of the first timer is set to 0.

In an example, based on the first time information, the timer T310 is paused and/or the data inactivity timer is paused. In some embodiments, the term “paused” may be understood as that the count value of the first timer remains unchanged and does not increase or decrease.

In some embodiments, the timer configured to determine an RLF is stopped at the time when the GNSS measurement is performed.

In some embodiments, the timer configured to determine an RLF is paused at the time when the GNSS measurement is performed.

In some embodiments, the timer configured to determine to switch from the connected state to the idle state is stopped at the time when the GNSS measurement is performed.

In some embodiments, the timer configured to determine to switch from the connected state to the idle state is paused at the time when the GNSS measurement is performed.

In some embodiments, the timer configured to determine an RLF is stopped at the time when the GNSS information expires.

In some embodiments, the timer configured to determine an RLF is paused at the time when the GNSS information expires.

In some embodiments, the timer configured to determine to switch from the connected state to the idle state is stopped at the time when the GNSS information expires.

In some embodiments, the timer configured to determine to switch from the connected state to the idle state is paused at the time when the GNSS information expires.

In some embodiments, the timer configured to determine an RLF is stopped at the start time of the GNSS measurement gap.

In some embodiments, the timer configured to determine an RLF is paused at the start time of the GNSS measurement gap.

In some embodiments, the timer configured to determine to switch from the connected state to the idle state is stopped at the start time of the GNSS measurement gap.

In some embodiments, the timer configured to determine to switch from the connected state to the idle state is paused at the start time of the GNSS measurement gap.

In some embodiments, the timer configured to determine an RLF is stopped at the start time of the satellite switch.

In some embodiments, the timer configured to determine an RLF is paused at the start time of the satellite switch.

In some embodiments, the timer configured to determine to switch from the connected state to the idle state is stopped at the start time of the satellite switch.

In some embodiments, the timer configured to determine to switch from the connected state to the idle state is paused at the start time of the satellite switch.

It should be noted that the above embodiments may be combined to form new embodiments.

In some embodiments, the timer T310 is started and/or stopped only when a continuous count reaches a threshold. In this case, it is recommended to stop the timer T310 at the first time, such that the timer T310 is capable of continuously counting again after the timer is restarted. At this time, a working mechanism of the timer T310 is more in line with an original design intention of the timer T310.

In some embodiments, the data inactivity timer is configured to count data transmission duration of the terminal device to determine whether to switch from the connected state to the idle state. Because the counted duration is cleared in the case that the data inactivity timer is stopped, it is more recommended to pause the data inactivity timer at the first time to retain the counted duration.

In some embodiments, the timer T310 is stopped at the time when the GNSS measurement is performed; and the data inactivity timer is paused at the time when the GNSS measurement is performed.

In some embodiments, the timer T310 is stopped at the start time of the satellite switch; and the data inactivity timer is paused at the start time of the satellite switch.

In summary, in the embodiments of the present disclosure, the first operation is performed on the first timer based on the time information related to the GNSS measurement and/or the satellite switch, which prevents the terminal device from entering the idle state during the GNSS measurement and/or the satellite switch. During the GNSS measurement and/or the satellite switch, the terminal device does not consider that an RLF occurs and trigger RRC connection re-establishment based on a relevant protocol. In this way, the terminal device is capable of directly performing data transmission upon completion of the GNSS measurement and/or the satellite switch, such that a data transmission delay caused by performing RRC connection re-establishment is avoided. In addition, during the GNSS measurement and/or the satellite switch, the terminal device is prevented from entering the idle state based on a relevant protocol. In this way, the terminal device does not need to consume more power for RRC connection re-establishment upon completion of the GNSS measurement and/or the satellite switch. This also avoids a data transmission delay caused by performing RRC connection re-establishment, such that the terminal device is capable of performing data transmission as soon as possible upon completion of the GNSS measurement and/or the satellite switch.

In the case that the first timer is the timer (such as the timer T310) configured to determine an RLF, the embodiments of the present disclosure enable the terminal device not to trigger RRC connection re-establishment during the GNSS measurement and/or the satellite switch. The terminal device is still in the RRC connected state upon completion of the GNSS measurement and/or the satellite switch, such that the terminal device is capable of performing data transmission as soon as possible upon completion of the GNSS measurement and/or the satellite switch.

In the case that the first timer is the timer (such as the data inactivity timer) configured to determine to switch from the connected state to the idle state, the embodiments of the present disclosure enable the terminal device not to trigger a switch from the connected state to the idle state during the GNSS measurement and/or the satellite switch. The terminal device is still in the RRC connected state upon completion of the GNSS measurement and/or the satellite switch, such that the terminal device is capable of performing data transmission as soon as possible upon completion of the GNSS measurement and/or the satellite switch.

In some embodiments, based on the first operation performed by the terminal device on the first timer based on the first time information, the terminal device correspondingly performs a second operation on a second timer based on second time information. In some embodiments, the second time information corresponds to the first time information. In the case that the first time information corresponds to a start time of the GNSS measurement, the second time information corresponds to an end time of the GNSS measurement. However, it should be noted that these embodiments may operate independently.

FIG. 3 is a flowchart of a method for performing operations based on timers according to some embodiments of the present disclosure. The method is applicable to a terminal device and includes the following process.

In process 220, a second operation is performed on a second timer based on second time information.

After the second time information is obtained, the second operation is performed on the second timer.

In some embodiments, the second time information is time information related to a GNSS measurement and/or a satellite switch. In some embodiments, the second time information is time information related to an end or stopping of the GNSS measurement. In some embodiments, the second time information is time information related to an end or stopping of the satellite switch. In some embodiments, the satellite switch includes at least one of a soft satellite switch or a hard satellite switch.

In an example, the satellite switch includes the hard satellite switch. During the hard satellite switch, to prevent co-channel interference between two communication satellites before and after the switch, the terminal device needs to disconnect from the current communication satellite and then establish a new connection to the new communication satellite during the hard satellite switch.

In some embodiments, the second time information includes at least one of: a time when the GNSS measurement is completed; a time when a result of the GNSS measurement is obtained; an end time of a GNSS measurement gap; or an end time of the satellite switch.

In some embodiments, a corresponding relationship is present between the second time information and first time information. In an example, the time when the GNSS measurement is completed corresponds to a time when the GNSS measurement is performed. In an example, the time when the result of the GNSS measurement is obtained corresponds to a time when GNSS information expires. In an example, the end time of the GNSS measurement gap corresponds to a start time of the GNSS measurement gap. In an example, the end time of the satellite switch corresponds to a start time of the satellite switch.

In some embodiments, the start time of the satellite switch is indicated by a network device (such as a base station or a core network device).

The network device indicates the start time of the satellite switch over at least one of: system message broadcasting; RRC dedicated signaling; a MAC CE; or a PDCCH.

It should be understood that a time when the terminal device performs the second operation and the second time are coincident or synchronous. In general, due to a specific delay under objective conditions, the time when the second operation is performed may be slightly later than the second time.

In some embodiments, the second timer triggers an interruption of communication between the terminal device and a satellite upon expiration

In some embodiments, the second timer includes at least one of: a timer configured to determine an RLF; a timer configured to initiate a neighboring cell measurement in the connected state; or a timer configured to determine to switch from the connected state to an idle state.

In some embodiments, the timer configured to determine an RLF includes a timer T310. In some embodiments, after the terminal device starts RLM, in the case that a quantity of continuously received downlink out-of-sync indications is equal to a first parameter, a start of the timer T310 is triggered. In the case that a quantity of continuously received downlink in-sync indications is equal to a second parameter during the process that the timer T310 is continuously running, the timer T310 is stopped to indicate that link synchronization has been recovered. In the case that the timer T310 expires, it is considered that an RLF is detected and an RRC connection re-establishment procedure is triggered. In some embodiments, the first parameter includes N310. In some embodiments, the second parameter includes N311.

In some embodiments, the timer configured to initiate a neighboring cell measurement in the connected state includes a timer T326. The terminal device initiates a neighboring cell measurement only in the case that the timer T326 is running.

In some embodiments, the timer configured to determine to switch from the connected state to the idle state includes a data inactivity timer. In some embodiments, in the case that the terminal device is in the connected state upon completion of data transmission, the data inactivity timer is started. In the case that the data inactivity timer expires, the terminal device switches from the connected state to the idle state.

In some embodiments, the second operation is an operation configured to recover from impact of the first operation on normal running of the timer. In some embodiments, the second operation is an operation configured to recover from impact of the first operation on normal running of the timer within a time period other than that related to the GNSS measurement and/or the satellite switch. In some embodiments, the second operation is configured to trigger the terminal device to continue running a first timer within a time period other than that related to the GNSS measurement and/or the satellite switch.

In some embodiments, the second operation includes: starting the second timer; or resuming the second timer.

In an example, in the case that the timer T310 is stopped based on the first time information, the timer T310 is restarted based on the second time information. In some embodiments, the term “stopped” may be understood as that the timer T310 is canceled or a count value of the timer T310 is set to 0. In some embodiments, the term “restarted” may be understood as that the timer T310 is rerun or the count value of the timer T310 increases or decreases again.

In an example, in the case that the timer T310 is paused based on the first time information, the timer T310 is resumed based on the second time information. In some embodiments, the term “paused” may be understood as that the count value of the timer T310 remains unchanged and does not increase or decrease. In some embodiments, the term “resumed” may be understood as that the count value of the timer T310 increases or decreases from an original value.

In an example, in the case that the data inactivity timer is stopped based on the first time information, the data inactivity timer is restarted based on the second time information. In some embodiments, the term “stopped” may be understood as that the data inactivity timer is canceled or a count value of the data inactivity timer is set to 0. In some embodiments, the term “restarted” may be understood as that the data inactivity timer is rerun or the count value of the data inactivity timer increases or decreases again.

In an example, in the case that the data inactivity timer is paused based on the first time information, the data inactivity timer is resumed based on the second time information. In some embodiments, the term “paused” may be understood as that the count value of the data inactivity timer remains unchanged and does not increase or decrease. In some embodiments, the term “resumed” may be understood as that the count value of the data inactivity timer increases or decreases from an original value.

In an example, the timer T326 is started based on the second time information. In some embodiments, the term “started” may be understood as that the timer T326 is run or a count value of the timer T326 increases or decreases again.

In some embodiments, the timer configured to determine an RLF is started at the time when the GNSS measurement is completed.

In some embodiments, the timer configured to determine an RLF is resumed at the time when the GNSS measurement is completed.

In some embodiments, the timer configured to initiate a neighboring cell measurement in the connected state is started at the time when the GNSS measurement is completed.

In some embodiments, the timer configured to determine to switch from the connected state to the idle state is started at the time when the GNSS measurement is completed.

In some embodiments, the timer configured to determine to switch from the connected state to the idle state is resumed at the time when the GNSS measurement is completed.

In some embodiments, the timer configured to determine an RLF is started at the time when the result of the GNSS measurement is obtained.

In some embodiments, the timer configured to determine an RLF is resumed at the time when the result of the GNSS measurement is obtained.

In some embodiments, the timer configured to initiate a neighboring cell measurement in the connected state is started at the time when the result of the GNSS measurement is obtained.

In some embodiments, the timer configured to determine to switch from the connected state to the idle state is started at the time when the result of the GNSS measurement is obtained.

In some embodiments, the timer configured to determine to switch from the connected state to the idle state is resumed at the time when the result of the GNSS measurement is obtained.

In some embodiments, the timer configured to determine an RLF is started at the end time of the GNSS measurement gap.

In some embodiments, the timer configured to determine an RLF is resumed at the end time of the GNSS measurement gap.

In some embodiments, the timer configured to initiate a neighboring cell measurement in connected state is started at the end time of the GNSS measurement gap.

In some embodiments, the timer configured to determine to switch from the connected state to the idle state is started at the end time of the GNSS measurement gap.

In some embodiments, the timer configured to determine to switch from the connected state to the idle state is resumed at the end time of the GNSS measurement gap.

In some embodiments, the timer configured to determine an RLF is started at the end time of the satellite switch.

In some embodiments, the timer configured to determine an RLF is resumed at the end time of the satellite switch.

In some embodiments, the timer configured to initiate a neighboring cell measurement in the connected state is started at the end time of the satellite switch.

In some embodiments, the timer configured to determine to switch from the connected state to the idle state is started at the end time of the satellite switch.

In some embodiments, the timer configured to determine to switch from the connected state to the idle state is resumed at the end time of the satellite switch.

It should be noted that the above embodiments may be combined to form new embodiments.

In some embodiments, the timer T310 is started and/or stopped only in the case that a continuous count reaches a threshold. In this case, it is recommended to stop the timer T310 at the first time, such that the timer T310 is capable of continuously counting again after the timer is restarted. At this time, a working mechanism of the timer T310 is more in line with an original design intention of the timer T310. In the case that the timer T310 is stopped at the first time, the timer T310 is started at the second time.

In some embodiments, the data inactivity timer is configured to count data transmission duration of the terminal device to determine whether to switch from the connected state to the idle state. Because the counted duration is cleared in the case that the data inactivity timer is stopped, it is more recommended to pause the data inactivity timer at the first time to retain the counted duration. In the case that the data inactivity timer is paused at the first time, the data inactivity timer is resumed at the second time.

In some embodiments, the timer T310 is started at the time when the GNSS measurement is completed; and the data inactivity timer is resumed at the time when the GNSS measurement is completed.

In some embodiments, the timer T310 is started at the end time of the satellite switch; and the data inactivity timer is resumed at the end time of the satellite switch.

In summary, in the embodiments of the present disclosure, the second operation is performed on the second timer based on the time information related to the GNSS measurement and/or the satellite switch, such that the terminal device resumes running of the timer upon completion of the GNSS measurement and/or the satellite switch, which avoids that the timer fails to normally run after communication is resumed.

FIG. 4 is a flowchart of a method for performing operations based on timers according to some embodiments of the present disclosure. The method is applicable to a terminal device and includes the following process.

In process 320, in the case that a first timer expires within a first time period, a third operation is not performed.

In some embodiments, the first time period is a time period related to a GNSS measurement and/or a satellite switch. In some embodiments, the first time period is a time period related to a start and end of the GNSS measurement or a time period related to initiation and stopping of the GNSS measurement. In some embodiments, the first time period is a time period related to a start and end of the satellite switch or a time period related to initiation and stopping of the satellite switch. In some embodiments, the satellite switch includes at least one of a soft satellite switch or a hard satellite switch.

In an example, the satellite switch includes the hard satellite switch. During the hard satellite switch, to prevent co-channel interference between two communication satellites before and after the switch, the terminal device needs to disconnect from the current communication satellite and then establish a new connection to the new communication satellite during the hard satellite switch.

In some embodiments, the first time period is a time period from a first time to a second time.

The first time includes at least one of: a time when the GNSS measurement is performed; a time when GNSS information expires; a start time of a GNSS measurement gap; or a start time of the satellite switch.

The second time includes at least one of: a time when the GNSS measurement is completed; a time when a result of the GNSS measurement is obtained; an end time of the GNSS measurement gap; or an end time of the satellite switch.

In some embodiments, a corresponding relationship is present between the first time and the second time.

In an example, the first time period is a time period from a time when the GNSS measurement is performed to a time when the GNSS measurement is completed.

In an example, the first time period is a time period from a time when the GNSS information expires to a time when the result of the GNSS measurement is obtained.

In an example, the first time period is a time period from the start of the GNSS measurement gap to the end of the GNSS measurement gap.

In an example, the first time period is a time period from the start of the satellite switch to the end of the satellite switch.

In some embodiments, the start time of the satellite switch is indicated by a network device (such as a base station or a core network device).

The network device indicates the start time of the satellite switch over at least one of: system message broadcasting; RRC dedicated signaling; a MAC CE; or a PDCCH.

In some embodiments, the third operation is an operation related to an interruption of communication between the terminal device and a satellite.

In some embodiments, the first timer includes a timer configured to determine an RLF. In the case that the timer configured to determine an RLF expires within the first time period, the third operation includes: triggering an RLF and/or performing RRC connection re-establishment. That is, in the case that the timer configured to determine an RLF expires within the first time period, an RLF is not triggered and/or RRC connection re-establishment is not performed.

In some embodiments, the timer configured to determine an RLF includes a timer T310. In some embodiments, after the terminal device starts RLM, in the case that a quantity of continuously received downlink out-of-sync indications is equal to a first parameter, a start of the timer T310 is triggered. In the case that a quantity of continuously received downlink in-sync indications is equal to a second parameter during the process that the timer T310 is continuously running, the timer T310 is stopped to indicate that link synchronization has been recovered. In the case that the timer T310 expires, it is considered that an RLF is detected and an RRC connection re-establishment procedure is triggered. In some embodiments, the first parameter includes N310. In some embodiments, the second parameter includes N311.

In some embodiments, the first timer includes a timer configured to determine to switch from a connected state to an idle state. In the case that the timer configured to determine to switch from the connected state to the idle state expires within the first time period, the third operation includes: entering the idle state. That is, in the case that the timer configured to determine to switch from the connected state to the idle state expires within the first time period, the idle state is not entered.

In some embodiments, the timer configured to determine to switch from the connected state to the idle state includes a data inactivity timer. In some embodiments, in the case that the terminal device is in connected state upon completion of data transmission, the data inactivity timer is started. In the case that the data inactivity timer expires, the terminal device switches from the connected state to the idle state.

In summary, in the embodiments of the present disclosure, based on the time period related to the GNSS measurement and/or the satellite switch, the third operation is not performed in the case that the first timer expires within the time period related to the GNSS measurement and/or the satellite switch. During the GNSS measurement and/or the satellite switch, the terminal device does not perform RRC connection re-establishment. In this way, the terminal device is capable of directly performing data transmission upon completion of the GNSS measurement and/or the satellite switch, such that a data transmission delay caused by performing RRC connection re-establishment is avoided. In addition, during the GNSS measurement and/or the satellite switch, the terminal device is prevented from entering the idle state. In this way, no more power needs to be consumed for RRC connection re-establishment after the GNSS measurement and/or the satellite switch is completed. This also avoids a data transmission delay caused by performing RRC connection re-establishment, such that the terminal device is capable of performing data transmission as soon as possible upon completion of the GNSS measurement and/or the satellite switch.

In the case that the first timer is the timer (such as the timer T310) configured to determine an RLF, the embodiments of the present disclosure enable the terminal device not to trigger RRC connection re-establishment during the GNSS measurement and/or the satellite switch. The terminal device is still in the RRC connected state upon completion of the GNSS measurement and/or the satellite switch, such that the terminal device is capable of performing data transmission as soon as possible upon completion of the GNSS measurement and/or the satellite switch.

In the case that the first timer is the timer (such as the data inactivity timer) configured to determine to switch from the connected state to the idle state, the embodiments of the present disclosure enable the terminal device not to trigger a switch from the connected state to the idle state during the GNSS measurement and/or the satellite switch. The terminal device is still in RRC connected state upon completion of the GNSS measurement and/or the satellite switch, such that the terminal device is capable of performing data transmission as soon as possible upon completion of the GNSS measurement and/or the satellite switch.

In some embodiments, in the case that the first timer expires outside the first time period, as illustrated in FIG. 5, the method further includes the following process.

In process 340, in the case that the first timer expires outside the first time period, the third operation is performed.

In some embodiments, the first time period is a time period related to a GNSS measurement and/or a satellite switch. In some embodiments, the first time period is a time period related to a start and end of the GNSS measurement or a time period related to initiation and stopping of the GNSS measurement. In some embodiments, the first time period is a time period related to a start and end of the satellite switch or a time period related to initiation and stopping of the satellite switch. In some embodiments, the satellite switch includes at least one of a soft satellite switch or a hard satellite switch.

In an example, the satellite switch includes the hard satellite switch. During the hard satellite switch, to prevent co-channel interference between two communication satellites before and after the switch, the terminal device needs to disconnect from the current communication satellite and then establish a new connection to the new communication satellite during the hard satellite switch.

In some embodiments, the first time period is a time period from a first time to a second time.

The first time includes at least one of: a time when the GNSS measurement is performed; a time when GNSS information expires; a start time of a GNSS measurement gap; or a start time of the satellite switch.

The second time includes at least one of: a time when the GNSS measurement is completed; a time when a result of the GNSS measurement is obtained; an end time of the GNSS measurement gap; or an end time of the satellite switch.

In some embodiments, a corresponding relationship is present between the first time and the second time.

In an example, the first time period is a time period from a time when the GNSS measurement is performed to a time when the GNSS measurement is completed.

In an example, the first time period is a time period from a time when the GNSS information expires to a time when the result of the GNSS measurement is obtained.

In an example, the first time period is a time period from the start of the GNSS measurement gap to the end of the GNSS measurement gap.

In an example, the first time period is a time period from the start of the satellite switch to the end of the satellite switch.

In some embodiments, the start time of the satellite switch is indicated by a network device (such as a base station or a core network device).

The network device indicates the start time of the satellite switch over at least one of: system message broadcasting; RRC dedicated signaling; a MAC CE; or a PDCCH.

In some embodiments, the third operation is an operation related to an interruption of communication between the terminal device and a satellite.

In some embodiments, the first timer includes a timer configured to determine an RLF. In the case that the timer configured to determine an RLF expires outside the first time period, the third operation includes: triggering an RLF and/or performing RRC connection re-establishment. That is, In the case that the timer configured to determine an RLF expires outside the first time period, an RLF is triggered and/or RRC connection re-establishment is performed.

In some embodiments, the timer configured to determine an RLF includes a timer T310. In some embodiments, after the terminal device starts RLM, in the case that a quantity of continuously received downlink out-of-sync indications is equal to a first parameter, a start of the timer T310 is triggered. In the case that a quantity of continuously received downlink in-sync indications is equal to a second parameter during the process that the timer T310 is continuously running, the timer T310 is stopped to indicate that link synchronization has been recovered. In the case that the timer T310 expires, it is considered that an RLF is detected and an RRC connection re-establishment procedure is triggered. In some embodiments, the first parameter includes N310. In some embodiments, the second parameter includes N311.

In some embodiments, the first timer includes a timer configured to determine to switch from a connected state to an idle state. In the case that the timer configured to determine to switch from the connected state to the idle state expires outside the first time period, the third operation includes: entering the idle state. That is, in the case that the timer time to switch from the connected state to the idle state expires outside the first time period, the idle state is entered.

In some embodiments, the timer configured to determine to switch from the connected state to the idle state includes a data inactivity timer. In some embodiments, in the case that the terminal device is in the connected state upon completion of data transmission, the data inactivity timer is started. In the case that the data inactivity timer expires, the terminal device switches from the connected state to the idle state.

In summary, in the embodiments of the present disclosure, based on the time period related to the GNSS measurement and/or the satellite switch, the third operation is performed in the case that the first timer expires outside the time period related to the GNSS measurement and/or the satellite switch. The terminal device performs RRC connection re-establishment not during the GNSS measurement and/or the satellite switch. In this way, the terminal device is capable of directly performing data transmission upon completion of the GNSS measurement and/or the satellite switch, such that a data transmission delay caused by performing RRC connection re-establishment is avoided. In addition, the terminal device enters the idle state not during the GNSS measurement and/or the satellite switch. In this way, no more power needs to be consumed for RRC connection re-establishment after the GNSS measurement and/or the satellite switch is completed. This also avoids a data transmission delay caused by performing RRC connection re-establishment.

In the case that the first timer is the timer (such as the timer T310) configured to determine an RLF, the embodiments of the present disclosure enable the terminal device to trigger RRC connection re-establishment not during the GNSS measurement and/or the satellite switch. The terminal device is still in RRC connected state upon completion of the GNSS measurement and/or the satellite switch, such that the terminal device is capable of perform data transmission as soon as possible upon completion of the GNSS measurement and/or the satellite switch.

In the case that the first timer is the timer (such as the data inactivity timer) configured to determine to switch from the connected state to the idle state, the embodiments of the present disclosure enable the terminal device to trigger a switch from the connected state to the idle state not during the GNSS measurement and/or the satellite switch. The terminal device is still in the RRC connected state upon completion of the GNSS measurement and/or the satellite switch, such that the terminal device is capable of perform data transmission as soon as possible upon completion of the GNSS measurement and/or the satellite switch.

### Exemplary Embodiment 1

In some embodiments, a terminal device performs a first operation on a running first timer based on first time information.

In some embodiments, the first time information includes at least one of:
a start time of a GNSS measurement;
a time when GNSS information expires;
a start time of a GNSS measurement gap; or
a start time of a hard satellite switch, namely a time when the terminal device disconnects from a current satellite, wherein the time may be indicated to the terminal device by a base station using system message broadcasting, RRC dedicated signaling, a MAC CE, a PDCCH, or the like.

In some embodiments, the first timer includes at least one of: a timer configured to determine an RLF; or a timer configured to determine to switch from a connected state to an idle state.

In some embodiments, the first operation includes: stopping the first timer; or pausing the first timer.

### Exemplary Embodiment 2

In some embodiments, a terminal device performs a second operation on a second timer based on second time information.

In some embodiments, the second time information includes at least one of: a time when a GNSS measurement is completed; a time when a result of the GNSS measurement is obtained; an end time of a GNSS measurement gap; or an end time of a hard satellite switch, namely a time when the terminal device disconnects from a current satellite, wherein the time may be indicated to the terminal device by a base station over system message broadcasting, RRC dedicated signaling, a MAC CE, a PDCCH, or the like.

In some embodiments, the second timer includes at least one of: a timer configured to initiate a neighboring cell measurement in a connected state; or a timer configured to determine to switch from a connected state to an idle state.

In some embodiments, the second operation includes: starting/restarting the second timer; or resuming the second timer.

### Exemplary Embodiment 3

In some embodiments, in the case that a timer T310 expires during a GNSS measurement and/or a hard satellite switch, a terminal device does not trigger an RLF or RRC connection re-establishment procedure; or in the case that the timer T310 expires and the terminal device is not performing a GNSS measurement and/or a hard satellite switch, the terminal device triggers an RLF or RRC connection re-establishment procedure.

In some embodiments, in the case that a data inactivity timer expires during a GNSS measurement and/or a hard satellite switch, a terminal device does not enter an idle state; or in the case that the data inactivity timer expires and the terminal device is not performing a GNSS measurement and/or a hard satellite switch, the terminal device enters the idle state.

In some embodiments, the method for performing operations based on timers provided in the embodiments of the present disclosure prevents the terminal device from triggering RRC connection re-establishment or entering the idle state during the GNSS measurement and/or the hard satellite switch. In this way, data transmission is performed as soon as possible after the GNSS measurement and/or the hard satellite switch is completed. In addition, a timer T326 is started after the GNSS measurement and/or the hard satellite switch is completed, which avoids late initiation of a neighboring cell measurement and a failure to perform an early measurement on a re-establishment cell due to expiration of the timer T326.

FIG. 6 is a block diagram of an apparatus for performing operations based on timers according to some embodiments of the present disclosure. The apparatus may be implemented as a part of a terminal device. The apparatus includes an execution module 610.

The execution module 610 is configured to perform a first operation on a first timer based on first time information.

The first time information is time information related to a GNSS measurement and/or a satellite switch.

The first time information includes at least one of: a time when the GNSS measurement is performed; a time when GNSS information expires; a start time of a GNSS measurement gap; or a start time of the satellite switch.

The first timer includes at least one of: a timer configured to determine an RLF; or a timer configured to determine to switch from a connected state to an idle state.

The timer configured to determine an RLF includes a timer T310.

The timer configured to determine to switch from the connected state to the idle state includes a data inactivity timer.

The first operation includes: stopping the first timer; or pausing the first timer.

The execution module 610 is further configured to perform a second operation on a second timer based on second time information.

The second time information is time information related to the GNSS measurement and/or the satellite switch.

The second time information includes at least one of: a time when the GNSS measurement is completed; a time when a result of the GNSS measurement is obtained; an end time of a GNSS measurement gap; or an end time of the satellite switch.

The second timer includes at least one of: a timer configured to determine an RLF; a timer configured to initiate a neighboring cell measurement in a connected state; or a timer configured to determine to switch from a connected state to an idle state.

The timer configured to determine an RLF includes a timer T310.

The timer configured to initiate a neighboring cell measurement in connected state includes a timer T326.

The timer configured to determine to switch from the connected state to the idle state includes a data inactivity timer.

The second operation includes: starting the second timer; or resuming the second timer.

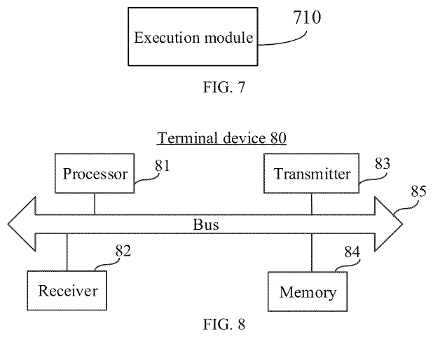

FIG. 7 is a block diagram of an apparatus for performing operations based on timers according to some embodiments of the present disclosure. The apparatus may be implemented as a part of a terminal device. The apparatus includes an execution module 710.

The execution module 710 is configured to: in the case that a first timer expires within a first time period, skip performing a third operation.

Alternatively, the execution module 710 is configured to: in the case that the first timer expires outside the first time period, perform the third operation.

The first time period is a time period related to a GNSS measurement and/or a satellite switch.

The first timer includes a timer configured to determine an RLF. The third operation includes: triggering an RLF and/or performing an RRC connection re-establishment.

The timer configured to determine an RLF includes a timer T310.

The first timer includes a timer configured to determine to switch from a connected state to an idle state. The third operation includes: entering the idle state.

The timer configured to determine to switch from the connected state to the idle state includes a data inactivity timer.

FIG. 8 is a schematic structural diagram of a terminal device according to some embodiments of the present disclosure. The terminal device 80 includes a processor 81, a receiver 82, a transmitter 83, a memory 84, and a bus 85.

The processor 81 includes one or more processing cores. The processor 81 runs various functional applications and performs information processing by running software programs and modules.

The receiver 82 and the transmitter 83 may be implemented as a communication component. The communication component may be a communication chip.

The memory 84 is connected to the processor 81 via the bus 85.

The memory 84 may be configured to store at least one instruction. The processor 81 is configured to load and execute the at least one instruction to perform the processes in the above method embodiments.

In addition, the memory 84 may be implemented using any type of volatile or non-volatile storage device or a combination thereof. The volatile or non-volatile storage device includes but is not limited to: a magnetic disk or an optical disc, an electrically erasable programmable read-only memory (EEPROM), an erasable programmable read-only memory (EPROM), a static random access memory (SRAM), a read-only memory (ROM), a magnetic memory, a flash memory, or a programmable ROM (PROM).

In some embodiments, a non-transitory readable storage medium including one or more instructions is further provided. For example, a memory including one or more instructions. The one or more instructions, when loaded and executed by a processor of a terminal device, cause the terminal device to perform the foregoing method for performing operations based on timers. For example, the non-transitory readable storage medium may be a ROM, a random access memory (RAM), a compact disc ROM (CD-ROM), a magnetic tape, a floppy disk, an optical data storage device, or the like.

The present disclosure further provides a chip. The chip includes a programmable logic circuit and/or one or more program instructions. A communication device equipped with the chip, when running, is caused to perform the method for performing operations based on timers in the above method embodiments.

The present disclosure further provides a computer-readable storage medium. The storage medium stores at least one instruction, at least one program segment, a code set, or an instruction set. The at least one instruction, the at least one program segment, the code set, or the instruction set, when loaded and executed by a processor, causes a communication device to perform the method for performing operations based on timers in the above method embodiments.

The present disclosure further provides a computer program product. The computer program product includes at least one program segment stored in a computer-readable storage medium. The at least one program segment, when read from the computer-readable storage medium and loaded and run by a processor of a communication device, causes the communication device to perform the method for performing operations based on timers in the above method embodiments.

It should be understood that the term “a plurality of” herein means two or more. The term “and/or” describes an association relationship between associated objects, and indicates three types of relationships. For example, the phrase “A and/or B” means (A), (B), or (A and B). The symbol “/” usually indicates an “or” relationship between associated objects.

Those of ordinary skill in the art should understand that all or some of the processes in the above embodiments may be implemented by hardware, or by instructing related hardware by using a program. The program may be stored in a computer-readable storage medium. The storage medium may be a ROM, a magnetic disk, an optical disc, or the like.

Described are merely exemplary embodiments of the present disclosure and are not intended to limit the present disclosure. Any modification, equivalent replacement, improvement, and the like, made within the spirit and principle of the present disclosure shall fall within the protection scope of the present disclosure.

1. A method for performing operations based on timers, applicable to a terminal device, the method comprising:
performing a first operation on a first timer based on first time information;
wherein the first time information is time information related to a global navigation satellite system (GNSS) measurement and/or a satellite switch.

2. The method according to claim 1, wherein the first time information comprises at least one of:
a time when the GNSS measurement is performed;
a time when GNSS information expires;
a start time of a GNSS measurement gap; or
a start time of the satellite switch.

3. The method according to claim 1, wherein the first timer comprises at least one of:
a timer configured to determine a radio link failure (RLF); or
a timer configured to determine to switch from a connected state to an idle state.

4. The method according to claim 3, wherein the timer configured to determine the RLF comprises a timer T310.

5. The method according to claim 3, wherein the timer configured to determine to switch from the connected state to the idle state comprises a data inactivity timer.

6. The method according to claim 1, wherein the first operation comprises:
stopping the first timer; or
pausing the first timer.

7. The method according to claim 1, further comprising:
performing a second operation on a second timer based on second time information;
wherein the second time information is time information related to the GNSS measurement and/or the satellite switch.

8. The method according to claim 7, wherein the second time information comprises at least one of:
a time when the GNSS measurement is completed;
a time when a result of the GNSS measurement is obtained;
an end time of a GNSS measurement gap; or
an end time of the satellite switch.

9. The method according to claim 7, wherein the second timer comprises at least one of:
a timer configured to determine a radio link failure (RLF);
a timer configured to initiate a neighboring cell measurement in a connected state; or
a timer configured to determine to switch from a connected state to an idle state.

10. The method according to claim 9, wherein the timer configured to determine the RLF comprises a timer T310.

11. The method according to claim 9, wherein the timer configured to initiate the neighboring cell measurement in the connected state comprises a timer T326.

12. The method according to claim 9, wherein the timer configured to determine to switch from the connected state to the idle state comprises a data inactivity timer.

13. The method according to claim 7, wherein the second operation comprises:
starting the second timer; or
resuming the second timer.

14. A terminal device, comprising:
a processor;
a transceiver, connected to the processor; and
a memory, configured to store one or more executable instructions;
wherein the processor is configured to load and execute the one or more executable instructions, to cause the terminal device to:
perform a first operation on a first timer based on first time information;
wherein the first time information is time information related to a global navigation satellite system (GNSS) measurement and/or a satellite switch.

15. The terminal device according to claim 14, wherein the first time information comprises at least one of:
a time when the GNSS measurement is performed;
a time when GNSS information expires;
a start time of a GNSS measurement gap; or
a start time of the satellite switch.

16. The terminal device according to claim 14, wherein the first timer comprises at least one of:
a timer configured to determine a radio link failure (RLF); or
a timer configured to determine to switch from a connected state to an idle state.

17. The terminal device according to claim 16, wherein the timer configured to determine the RLF comprises a timer T310.

18. The terminal device according to claim 16, wherein the timer configured to determine to switch from the connected state to the idle state comprises a data inactivity timer.

19. The terminal device according to claim 14, wherein the first operation comprises:
stopping the first timer; or
pausing the first timer.

20. A chip, comprising:
a programmable logic circuit and/or one or more program instructions, wherein a communication device equipped with the chip, when running, is caused to:
perform a first operation on a first timer based on first time information;
wherein the first time information is time information related to a global navigation satellite system (GNSS) measurement and/or a satellite switch.
